(19) United States
(12) Patent Application Publication
(10) Pub. No.: US 2009/0085750 A1
(43) Pub. Date: Apr. 2, 2009

(54) Extended RFID tag

(75) Inventors: Michele A. Waldner, Minneapolis, MN (US); David P. Erickson, Stillwater, MN (US); James P. McGee, Cedar, MN (US); Swagata R. Banerjee, North Oaks, MN (US); Robert A. Sainati, Bloomington, MN (US)

Correspondence Address: 3M INNOVATIVE PROPERTIES COMPANY, PO BOX 33427, ST. PAUL, MN, 55133-3427, US

(73) Assignee: 3M Innovative Properties Company, St. Paul, MN (US)

(21) Appl. No.: 11/904,625

(22) Filed: Sep. 27, 2007

(51) Int. Cl. G08B 13/14

(52) U.S. Cl. 340/572.7

(57) ABSTRACT

The invention is directed to an extended radio-frequency identification (RFID) tag. The extended RFID tag includes an ultra-high frequency (UHF) RFID tag having a dipole antenna attached to a first surface of a substrate. The extended RFID tag further includes an antenna extension attached to the UHF RFID tag and overlapping at least a portion of the dipole antenna for electromagnetically coupling the antenna extension and the dipole antenna in operation. The extended RFID tag further includes an insulator positioned between the dipole antenna and the antenna extension to electrically isolate the dipole antenna from the antenna extension.

### TECHNICAL FIELD

The invention relates to the use of radio frequency identification systems and, more specifically to radio frequency identification tags for use in radio frequency identification systems.

### BACKGROUND

Radio-Frequency Identification (RFID) technology has become widely used in virtually every industry, including transportation, manufacturing, waste management, postal tracking, airline baggage reconciliation, and highway toll management. A typical RFID system includes RFID tags, an RFID reader having an antenna, and a computing device. The RFID reader includes a transmitter that may provide energy or information to the tags, and a receiver to receive identity and other information from the tags.

The transmitter outputs RF signals through the antenna to create an electromagnetic field that enables the tags to return an RF signal carrying the information. The transmitter makes use of an amplifier to drive the antenna with a modulated output signal. A conventional tag may be an “active” tag that includes an internal power source, or a “passive” tag that is energized by the field. Once energized, the tags communicate using a pre-defined protocol, allowing the RFID reader to receive information from one or more tags. The computing device serves as an information management system by receiving the information from the RFID reader, and performing some action, such as updating a database or sounding an alarm. In addition, the computing device serves as a mechanism for programming data into the tags via the transmitter.

In general, the information received from the tags is specific to the particular application, but often provides identification for an item to which the tag is fixed, which may be a manufactured item, a vehicle, an animal or individual, or virtually any other tangible article. Additional data may also be provided for the article. The tag may be used during a manufacturing process, for example, to indicate a paint color of an automobile chassis during manufacturing or other useful information.

### SUMMARY

In general, the invention relates to an extended RFID tag for use in an RFID system. The extended RFID tag may be utilized in an RFID system that includes one or more “smart” storage areas for example. The smart storage areas are designated storage areas that are equipped with RFID interrogation capability to aid in tracking and locating items (e.g., documents or files) positioned within the storage areas. The RFID interrogation capability of smart storage areas may read extended RFID tags associated with the items stored in the respective storage areas. Examples of smart storage areas include a shelving unit, a cabinet, a vertical file separator, a smart cart, a desktop reader, or a similar location.

The extended RFID tag can improve the performance of an RFID system. For example, the extended tag may increase the reception area of a standard UHF RFID tag within the near field (i.e., fringing field or bound field) without significantly altering the far field (i.e., radiating field) operating frequency of the dipole antenna in the standard UHF RFID tag. In other words, an extended RFID tag may increase the reception of a standard UHF RFID tag without requiring the dipole antenna to be retuned or rebalanced to a new operating frequency.

The extended RFID tag may also allow RFID communication at increased distances between the extended RFID tag and the antenna structure of the smart shelf, thereby improving the tolerance with respect to variation in the placement and orientation of items within the storage area as well as the placement and orientation of the tag relative to the item. As another example, use of the extended RFID tag described herein may allow an RFID system to be implemented with reduced power consumption. For example, increased electromagnetic coupling provided by the extended RFID tag may allow the strength of the electromagnetic field produced by the transmitter to be reduced without compromising performance in the RFID system.

In one embodiment, the invention is directed to an extended radio-frequency identification (RFID) tag. The extended RFID tag includes an ultra-high frequency (UHF) RFID tag having a dipole antenna attached to a first surface of a substrate. The extended RFID tag further includes an antenna extension attached to the UHF RFID tag and overlapping at least a portion of the dipole antenna for electromagnetically coupling the antenna extension and the dipole antenna in operation. The extended RFID tag further includes an insulator positioned between the dipole antenna and the antenna extension to electrically isolate the dipole antenna from the antenna extension.

In another embodiment, the invention is directed to a radio-frequency identification (RFID) system. The RFID system includes a storage area for storing an item. The RFID system further includes an extended radio-frequency identification (RFID) tag applied to the item. The RFID system further includes a transmitter proximate the storage area to produce an electromagnetic field. The RFID system further includes a reader coupled to the transmitter to receive a backscattered electromagnetic signal from the extended RFID tag. The extended RFID tag includes an ultra-high frequency (UHF) RFID tag having a dipole antenna attached to a first surface of a substrate. The extended RFID tag further includes an antenna extension attached to the UHF RFID tag and overlapping at least a portion of the dipole antenna for electromagnetically coupling the antenna extension and the dipole antenna in operation. The extended RFID tag further includes an insulator positioned between the dipole antenna and the antenna extension to electrically isolate the dipole antenna from the antenna extension.

In another embodiment, the invention is directed to a method. The method includes selecting an ultra-high frequency (UHF) radio-frequency identification (RFID) tag having an integrated circuit and a dipole antenna having two radiators coupled to the integrated circuit. The method further includes selecting an antenna extension having a length that exceeds a length of one of the radiators of the UHF RFID tag. The method further includes applying the antenna extension to the UHF RFID tag to overlap a portion of one of the radiators of the dipole antenna, wherein the antenna extension and the UHF RFID tag together form an extended RFID tag.

In RFID systems where a number of closely spaced items exist, it can be advantageous to utilize coupling between the metallic extensions of the extended tags to assist in the propagation of energy to extensions of surrounding tags. In this way, use of extended RFID tags may increase coupling between items as positional variances occur without substantially varying the far field operating frequency of the extended tags.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example radio frequency identification (RFID) system used for document and file management.

FIG. 2 is a block diagram illustrating an example smart storage area implemented as a file shelf containing an embedded signal line structure.

FIG. 3 is a perspective diagram illustrating an example orientation for signal line structure of an RFID reader relative to a tag associated with a document or file.

FIG. 4 is a perspective diagram illustrating an exemplary signal line structure, which may be incorporated into the smart storage area.

FIG. 5 is a perspective diagram illustrating an exemplary RFID system utilizing a plurality of extended RFID tags according to this disclosure.

FIG. 6 is a block diagram illustrating a top view of one of the extended RFID tags shown in FIG. 5 according to this disclosure.

FIGS. 7A-7B are schematic diagrams illustrating top views of two different embodiments of the extended RFID tag shown in FIG. 6.

FIGS. 8A-8B are schematic diagrams illustrating cross-sectional views of the extended RFID tags shown in FIGS. 7A-7B, respectively.

FIG. 9 is a perspective view of a test environment that was modeled in order to simulate the operation of an example extended RFID tag.

FIG. 10 is a graph illustrating a set of pullout profiles modeled for a standard, unmodified UHF RFID tag.

FIG. 11 is a graph illustrating a set of pullout profiles determined upon modeling an exemplary extended RFID tag 60 according to this disclosure.

FIG. 12 is a graph illustrating another set of pullout profiles 140 determined upon modeling a second exemplary extended RFID tag 60 according to this disclosure.

FIG. 13 is an s-parameter smith chart illustrating the electrical characteristics of a standard, unmodified UHF RFID tag verses an extended RFID tag according to this disclosure.

FIG. 14 is a perspective view of another exemplary RFID system according to this disclosure.

### DETAILED DESCRIPTION

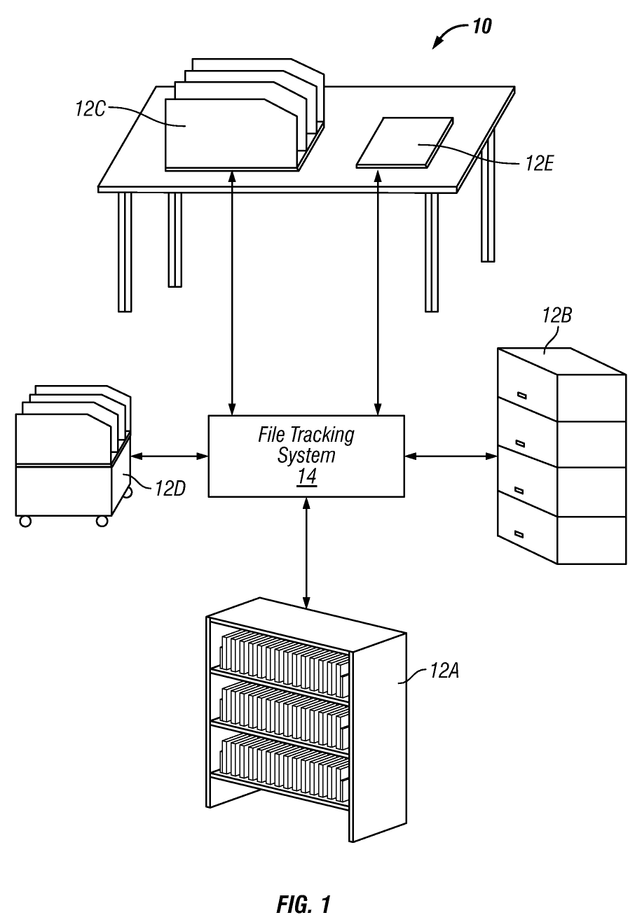

FIG. 1 is a block diagram illustrating an example radio frequency identification (RFID) system 10 for document and file management. Despite some interest in converting offices to paperless environments in which paper documents are entirely replaced by electronic versions of those documents, a number of industries continue to rely heavily on paper documents. Examples include law offices, government agencies, and facilities for storing business, criminal, and medical records. These files may be positioned in a number of “smart storage areas” 12, e.g., on an open shelf 12A, a cabinet 12B, a vertical file separator 12C, a smart cart 12D, a desktop reader 12E, or a similar location, as shown in FIG. 1.

In this manner, smart storage areas 12 may be provided at multiple locations within an organization, as opposed to in a single file room. For example, a smart storage area 12 may be associated with a particular location, e.g., a docketing shelf, and thus may be referred to or considered to be “dedicated” shelves. As also described below, smart storage areas 12 could be located near individual offices or other areas in, for example, a hospital or clinic, a law firm, an accounting firm, a brokerage house, or a bank, to enable files to be tracked not only when they are located in a central file room, but also when they are located at distributed locations.

The term “smart storage area” is used herein generally to refer to a storage area that is equipped with RFID interrogation capability to aid in tracking and locating items positioned within the storage areas. In particular, the RFID interrogation capability of smart storage areas 12 may read RFID tags associated with the items stored in the respective storage areas. In other words, RFID tags may be associated with or applied to items of interest. The tag may even be embedded within the item or the packaging of the item so that the tag is at least substantially imperceptible, which can help to prevent detection and tampering. Thus it would be possible to “source-mark” items with an RFID tag, such as inserting an RFID tag into or applying an RFID tag to an item during its manufacture, as with a file folder, document, book, or the like.

RFID tags or labels are made by various manufacturers, including Texas Instruments of Dallas Tex., under the designation “Tag-it.” An RFID tag typically includes an integrated circuit with a certain amount of memory, a portion of which may be used to write certain information to the tag, and another portion of which may be used to store additional information to the tag. The integrated circuit is operatively connected to an antenna that receives RF energy from a source and also backscatters RF energy in a manner well known in the art. It is this backscattered RF energy that provides a signal that may be received by an interrogator, commonly referred to as a reader, within file tracking system 14 to obtain information about the RFID tag, and the item with which it is associated.

RFID system 10 may operate within an ultra high frequency (UHF) range of the electromagnetic spectrum, such as between 900 MHz and 3.0 GHz, which is often used for Industrial, Scientific and Medical (ISM) applications. However, other frequencies may be used for RFID applications, and the invention is not so limited. As another example, RFID systems may operate at lower frequency of 13.56 MHz, with an allowable frequency variance of ±7 kHz.

The RFID interrogators or reader pads of smart storage areas 12 communicate information to file tracking system 14 that provides a central data store, e.g., within one or more databases of a relational database management system (RDBMS) for aggregation of the position information. Example information includes position information for the particular items or information read from the RFID chip. For example, RFID system 10 may track medical files and information may include patent identifiers, file identifiers, status, physician information, case information and the like. File tracking system 14 may be networked or otherwise coupled to one or more computers so that individuals at various locations can access data relative to those items.

Collection and aggregation of the information may be useful for a number of purposes. For example, a user may request the location of a particular item or group of items, such as a file or a group of books. File tracking system 14 may retrieve the file location information from the data store, and report to the user the last location at which the items were located within one of the storage areas. Optionally, the system can re-poll or otherwise re-acquire the current location of the item to verify that the item is in the location indicated in the database.

As another example, file-tracking system 14 may notify a user when an item is placed at a certain location and is ready for use. For example, an attorney may be notified that a file is ready for review and recently placed at his or her desk. Naturally, file tracking system 14 could be applied to legal files stored in court rooms or court houses, and used by court personnel such as judges, clerks, and the like. Similarly, if patient files are located in a designated area, a medical professional may be notified (perhaps through a cellular telephone or a pager, or by e-mail) that the file (and perhaps the person to whom the file relates) is ready for review.

The fact that the file was located at a certain location awaiting further processing can be recorded by file tracking system 14 as part of a history of the location of that item. Note that a certain file located on a certain shelf or other storage location, on which a certain person is expected to work, is different than a storage room containing a large group of files (perhaps) awaiting work by any person within a group or organization. Stated differently, the certain shelf having a certain file for a certain person is specific to that person, whereas a general file room housing all files for all members of a group is not specific to anyone.

In addition, the information collected by RFID system 10 may be useful in tracking, for example, cycle time in processes, efficiency of one or more people who work with the files, and efficiency of the process. This information can also provide a type of location archive if the information is maintained within the software system.

Some of the smart storage areas 12 of system 10 may be equipped with one or more signal line structures that provide propagating wave guides for interrogating the files, e.g., to aid in determining which files are located at each of the storage areas 12. For example, one or more signal line structures are positioned within shelving units of open shelf 12A to create electromagnetic fields for communicating with the RFID tags associated with the files. Similarly, signal line structures may be located within cabinet 12B, vertical file separator 12C, smart cart 12D, desktop reader 12E, and the like. Existing shelves can be retrofitted to include the signal line structures, or the signal line structures may be built into a shelf and purchased as a unit with the shelf. As another example, the signal line structure may be built into a frame or housing (e.g., back panel) of a smart storage area 12.

Each of smart storage areas 12 may include a signal line structure control system to energize the signal line in the signal line structure for interrogating, or polling, the RFID tags. If polling is performed continuously, a controller within the signal line structure control system may include a circuit for multiplexing signals through multiple signal lines in a signal line structure sequentially. The signal line structure control system may cause the signal lines to interrogate portions of the smart storage area 12 in a predetermined order. The signal line structure control system may include one or more control nodes, i.e., subcontrollers, that operate to control a subset of the signal lines. The number, location, and other characteristics of the signal line associated with a given control node may be determined by the user. For example, if it is desired to poll the shelves quickly, more control nodes may be added to the system. Another approach is for the user to configure or customize the signal line structure control system so that control nodes or portions of the smart storage area 12 are polled in a sequence specified by the user. For example, if one portion of a smart storage area 12 is unavailable for use at certain times, then the RFID tags in that area need not be interrogated during those times.

As described in detail herein, the signal line or signal lines, in a signal line structure, used within each of smart storage areas 12 may be designed to develop electromagnetic fields of at least certain strengths within “interrogation regions” within the storage areas 12. This may be advantageous for one or more reasons, including improving the accuracy of file detection throughout the interrogation regions of a given smart storage area 12. The magnetic field created by the signal line may be used to power the tags associated with the items within the smart storage area 12, and the amount of energy induced in each tag is generally proportional to the strength of the electromagnetic field surrounding the signal line. Advantageously, the signal line structure may be utilized to produce a field having a magnitude over an interrogation period that exceeds a threshold magnitude for energizing an RFID tag. In other words, the signal line structure may controlled to produce an electromagnetic field having a magnitude that meets or exceed an interrogation threshold (e.g., 100-115 dBμA/m) sufficient for communication with extended RFID tags at distances of up to several inches from the signal line structure. Consequently, the techniques described herein can improve the likelihood that all or substantially all of the tags associated with the items positioned within the storage areas 12 can be energized, and the items can be successfully detected.

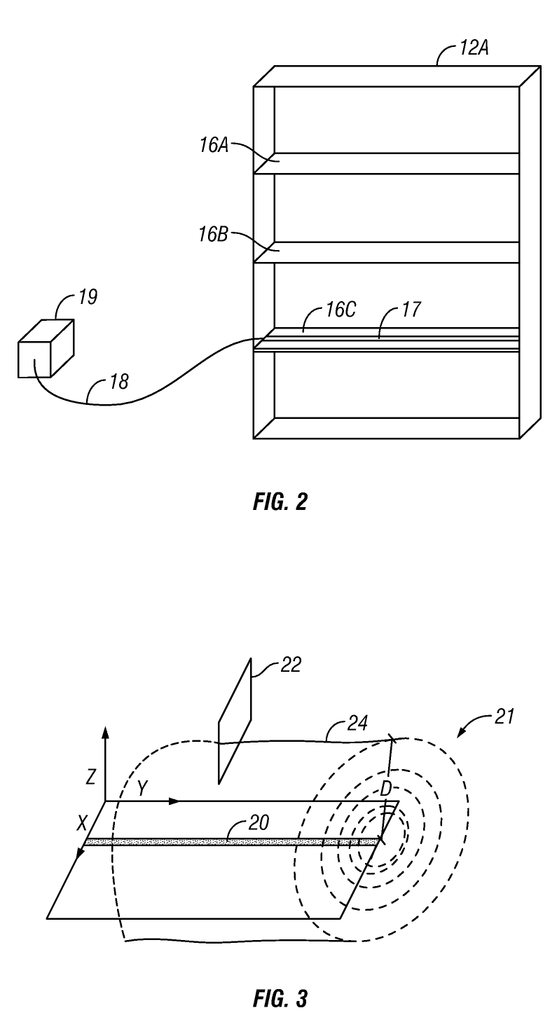

FIG. 2 is a block diagram illustrating an exemplary embodiment of smart storage area 12A of FIG. 1. In this example embodiment, smart storage area 12A includes multiple shelves 16A-16C (collectively, “shelves 16”). Of course, in other embodiments, smart storage area 12A may contain more or fewer than three shelves. In the example of FIG. 2, smart storage area 12A contains shelf 16C having a signal line 17 of a signal line structure. Signal line 17 may be electrically coupled to an RFID reader 19 through a cable 18. Cable 18 may be any type of cable with the ability to transmit signals to and from RFID reader 19, for example a standard RG58 coax cable. One example of RFID reader 19 is Sirit Infinity 510 reader sold by Sirit, Inc. of Toronto, Canada. Books, folders, boxes, or other items containing RFID tags may be placed upon shelf 16C. RFID reader 19 powers signal line 17 through cable 18. When powered, signal line 17 generates an electromagnetic field, as described in further detail below. The electromagnetic field powers RFID tags located on the shelf 16C. The powered RFID tags may backscatter RF signals including information which is received by signal line 17 and electrically transmitted to RFID reader 19 through cable 18. For example, an RFID tag affixed to a folder positioned on shelf 16C may backscatter RF signals to RFID reader 19 acknowledging that the RFID tag (and correspondingly, the folder) is located on the shelf.

In other embodiments, each of shelves 16 may contain a signal line 17 of a signal line structure. In such embodiments, each shelf 16 may have a separate associated RFID reader 19. In another embodiment, multiple shelves 16 within smart storage area 12A may be cabled together to connect to a single reader 19. In such an embodiment, reader 19 may receive an acknowledgement indicating that a folder containing an RFID tag is located on a particular one of shelves 16 in smart storage area 12A.

In yet another embodiment, multiple smart storage areas 12 may be connected to each other. For example, cabling may be used to interconnect shelf 16C in smart storage area 12A with a shelf in smart storage area 12B, where the shelf in storage area 12B is substantially similar to shelf 16C. In such embodiments, a single reader 19 may interrogate items positioned within storage areas 12A and 12B to read information from the tags associated with the items and determine the location of a particular folder within smart storage area 12A or smart storage area 12B. Although described for purposes of example with respect to smart storage area 12A and 12B, any of smart storage areas 12 may include one or more signal lines 17 of a signal line structure that are used to interrogate items within the storage areas 12 as described herein. Additionally, embodiments using one or more RFID readers 19 connected to one or more shelves 16 have been described.

FIG. 3 is a perspective diagram illustrating an example orientation for a signal line structure 20 relative to an RFID tag 22 associated with an item (not shown) located within one of smart storage areas 12. In many RFID applications, such as the smart storage areas 12 of RFID system 10, it is often advantageous to create a large electromagnetic field 21. In this case, electromagnetic field extends generally to form half of a cylindrical shape above and to the side of signal line structure 20, as indicated by the dotted lines, without substantial extension below a ground plane of the signal line structure to form an interrogation region 24. In particular, the field 21 has a magnitude that meets or exceeds a minimum interrogation threshold needed to energize the tag 22 throughout a substantial portion of interrogation region 24 to provide reliable communications throughout the interrogation region. For example, signal line structure 20 may generate an electromagnetic field capable or communicating with RFID tag 22 at a distance (D) by extending a near-field component of the electromagnetic field substantially beyond distances realized by conventional structures (e.g., approximately 15 mm 0.59 inches or less from signal line structure 20). Each of smart storage areas 12 may utilize one or more signal lines 20 of a signal line structure capable of producing an electromagnetic field that meets or exceeds an interrogation threshold for energizing tags throughout the smart storage area.

An extended RFID tag, as described herein, can improve the detection and tracking of items in a smart storage area 12 by increasing the electromagnetic coupling between the tag 22 and the signal line structure and also by increasing the likelihood that a portion of the tag 22 will receive an electromagnetic field that meets or exceeds the interrogation threshold for energizing tags. In addition, an extended RFID tag can improve the tolerance in the RFID system with respect to variation in placement and orientation of both the tag 22 and the item to which the tag is attached.

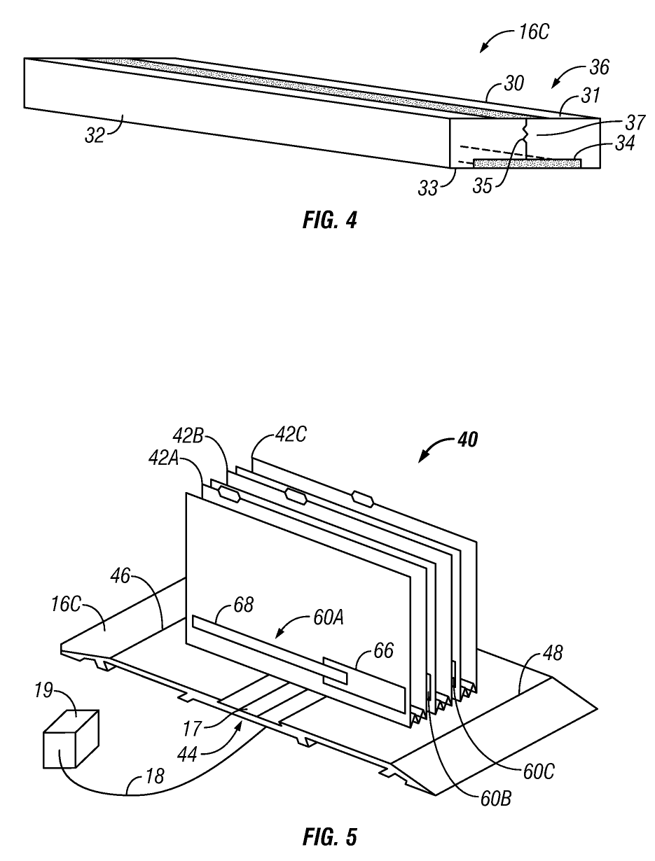

FIG. 4 is a perspective diagram illustrating an exemplary signal line structure 36, which may be incorporated into shelf 16C of FIG. 2. Shelf 16C includes substrate 32 and signal line structure 36. Signal line structure 36 includes at least one signal line 30 electrically connected to a ground plane 34 via a load 35, which may be an electrical resistor. Signal line 30 may be formed or placed onto of a top surface 31 of shelf 16C, and ground plane 34 may be formed or placed onto a bottom surface 33 of shelf 16C. Signal line 30 and ground plane 34 may be separated by substrate 32. Substrate 32 may be made from a polystyrene sheet, or other type of substrate material. As one example, signal line 30 and ground plane 34 may be composed of copper tape. In one example embodiment, the width of ground plane 34 may be three times the width of signal line 30.

RFID reader 19 (FIG. 2) may be coupled to signal line structure 36 via cable 18. Cable 18 may attach to a connector (not shown in FIG. 2) on a side surface 37 of the substrate 32. The connector may electrically connect signal line 30 to a first conducting portion of cable 18 and ground plane 34 to a second conducting portion of cable 18. To avoid impedance mismatches between RFID reader 19 and the connector, a matching structure may be used to efficiently couple power from RFID reader 19 to signal line 30 and reduce reflections at the connector.

In other embodiments, signal line structure 36 may include a plurality of signal lines substantially similar to signal line 30. Examples of other signal line structures that contain a plurality of signal lines are described in co-pending application Ser. No. ______, filed on Sep. 27, 2007, entitled SIGNAL LINE STRUCTURE FOR A RADIO-FREQUENCY IDENTIFICATION SYSTEM, Attorney Docket No. 63614US002/1004-312US01, the entire contents of which is incorporated by reference herein.

FIG. 5 is a perspective diagram illustrating an exemplary RFID system 40 utilizing a plurality of extended RFID tags 60A-60C (collectively, “extended RFID tags 60”) according to this disclosure. RFID system 40 may be a subset of the RFID system 10 shown in FIG. 1 and may include the same or similar components as those shown in FIGS. 1 and 2. In this example, RFID system 40 includes shelf 16C, reader 19, cable 18, and folders 42A-42C (collectively, “folders 42”). Shelf 16C includes a signal line 17 located on a top side of shelf 16C and a ground plane (not shown) located on the underside of shelf 16C. The signal line 17 and the ground plane together provide a signal line structure 44 that may function as a transmit/read antenna for RFID reader 19 in RFID system 40.

The reader 19 may be operatively connected to signal line structure 44 via cable 18. Reader 19 may direct signal line structure 44 to produce an electromagnetic field proximate to signal line structure 44 as shown in FIG. 3. The “energization region” of signal line structure 44 may refer to the area proximate to signal line structure 44 in which the electromagnetic field is above an interrogation threshold for energizing extended RFID tags 60. In other words, the electromagnetic field in an energization region has a magnitude that meets or exceeds a minimum interrogation threshold needed to energize the extended RFID tags 60 located within the energization region.

Cable 18 provides communication between reader 19 and signal line structure 44. A first conducting portion of cable 18 is electrically coupled to signal line 17 and a second conducting portion of cable 18 is electrically coupled to the ground plane (not shown). Cable 18 may also provide power to signal line structure 44.

The set of folders 42 includes individual folders 42A, 42B, 42C and extended RFID tags 60A, 60B, 60C applied to each of the folders 42A, 42B, 42C, respectively. The folders 42 may contain documents, such as medical records used in a medical office or case files used in a law firm. As shown in FIG. 5, the extended RFID tags 60 are applied to each of the folders 42 near the bottom of the folders when the folders are standing in a vertical and upright position. Such a configuration may be advantageous because extended RFID tags 60 can be located near signal line structure 44 and within the energization region of the signal line structure in RFID system 40. Extended RFID tags 60 may be applied to folders 42 in various other locations inside or outside of each of the folders 42 and in various orientations with respect to the folders 42, so that some portion of each of the extended RFID tags 60 is within the energization region of signal line structure 44 when the folders 42 are stored on shelf 16C.

When an extended RFID tag is applied to an item, the portion of the item that is in direct contact with the extended tag may be referred to as the “readable area” of the tagged item. When a portion of the readable area of a tagged item is within the energization region of signal line structure 44, the RFID system 40 is able to energize the RFID tag and track the item. Extended RFID tags 60, as described herein, can be designed to have a surface area that is larger than the surface area of a standard tag, thus allowing the extended RFID tag to establish direct contact with a greater portion of a tagged item. Accordingly, an extended RFID tag can improve the readable area of the tagged item.

Extended RFID tags 60 may provide improved tolerance with respect to placement of the tagged items within the RFID system 40. As shown in FIG. 5, for example, extended RFID tags 60 can be placed in a substantially horizontal position on folders 42 so that a large portion of each of the extended RFID tags 60 runs parallel to the bottom edge of each of the folders 42. This orientation generates a large readable area across the bottom of each of the folders 42. This can allow for increased variation in the placement of individual folders 42 on shelf 16C while still maintaining at least some portion of the readable area of each folder within the energization region of signal line structure 44. Rather than requiring that all of the folders 42 be precisely positioned relative to signal line 17 (e.g., placed substantially halfway between edges 46, 48 of shelf 16C as shown in FIG. 5), the folder position may vary front-to-back without compromising communication. That is, one folder could be placed closer to edge 46 of shelf 16C and another folder could be placed closer to edge 48 of shelf 16C. In such a case, a portion of each extended RFID tag 60 would still be located proximate to signal line structure 44 and within the energization region of signal line structure 44. Although FIG. 5 illustrates one tag orientation for purposes of example, the extended RFID tags 60 can be located and oriented in any direction inside or outside each of the folders 42 to increase the readable area of the folders 42 and to position the readable area to allow for anticipated variations in folder placement. In this manner, extended RFID tags 60 may provide greater tolerance with respect to varied placement of the extended RFID tags 60 on the folders 42 and with respect to the positioning of the folders within shelf 16C.

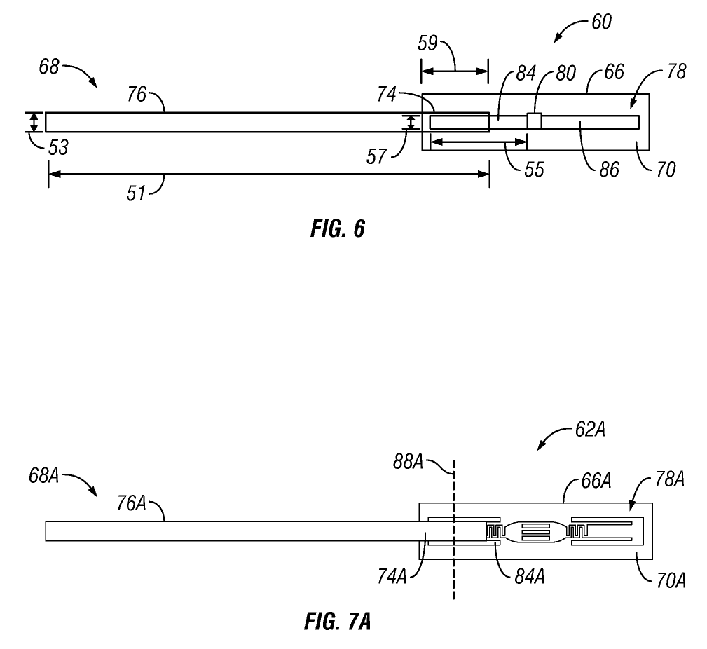

FIG. 6 is a schematic diagram illustrating a top view of the extended RFID tag 60 shown in FIG. 5 according to this disclosure. Extended RFID tag 60 provides improved tolerance in an RFID system with respect to variance in the placement and orientation of both the extended RFID tag 60 and the tagged item. In the example of FIG. 6, extended RFID tag 60 includes UHF RFID tag 66 and antenna extension 68 (herein referred to as “extension 68”). UHF RFID tag 66 includes RFID functionality by which extended RFID tag 60 may communicate with signal line structure 44 in RFID system 40. For example, UHF RFID tag 66 includes a dipole antenna 78 and RFID electrical circuit 80 formed on substrate 70 and configured for operating in the ultra high frequency (UHF) range of the electromagnetic spectrum, such as between 900 MHz and 3.0 GHz.

Substrate 70 provides a foundation for the other components of UHF RFID tag 66 and a means for securing the UHF RFID tag 66 to an item such as folder 42A. Substrate 70 may include an adhesive coating by which a user can readily apply extended RFID tag 60 to an item. In some embodiments, substrate 70 may be constructed using materials having dielectric or insulating properties, e.g., paper or polyester. A substrate that is constructed from insulating materials can serve both as an insulator and as a foundation for the extended RFID tag 60 and provide electrical isolation between extension 68 and antenna 78.

Antenna 78 is provided for receiving an electromagnetic field and transmitting or backscattering information onto the electromagnetic field. As discussed, Antenna 78 may be a dipole antenna having two radiators 84, 86 formed along a central longitudinal axis of UHF RFID tag 66. Antenna 78 is electrically connected to electrical circuit 80 and attached to a face of substrate 70 either on the same or on opposite surface as electrical circuit 80.

Electrical circuit 80 controls the communication between UHF RFID tag 66 and reader 19, and may also store identification information or other information relating to the item to which the extended RFID tag 60 has been applied. Electrical circuit 80 typically includes an integrated circuit that is electrically connect to antenna 78 and can be attached to a face of substrate 70.

Extension 68 is an elongated conductive extension that is not directly electrically connected to the components of UHF RFID tag 66, but instead electromagnetically couples to antenna 78. In other words, extension 68 may be attached to UHF RFID tag 66 such that extension 68 is electrically isolated from antenna 78. In this way, extension 68 and antenna 78 are not conductively connected, e.g., there is no direct metal-to-metal contact or galvanic connection between extension 68 and antenna 78. As a result, an electromagnetic field produced by either a reader antenna or a signal line structure may induce a time-varying current in extension 68, and the time-varying current induced in extension 68 may generate a localized electromagnetic field that can be received by dipole antenna 78 of UHF RFID tag 66. As described below, the extension 68 may capacitively or inductively couple to the dipole antenna 78.

In one embodiment, substrate 70 of UHF RFID tag 66 may provide electrical isolation between extension 68 and antenna 78. Alternatively, an insulator may be formed between extension 68 and antenna 78 to provide electrical isolation. Extension 68 can be made from any conductive or metallic material. As one example, extension 68 may be made from copper. Extension 68 may also include an adhesive coating so that a user can readily apply the extended RFID tag 60 to an item, such as folder 42A.

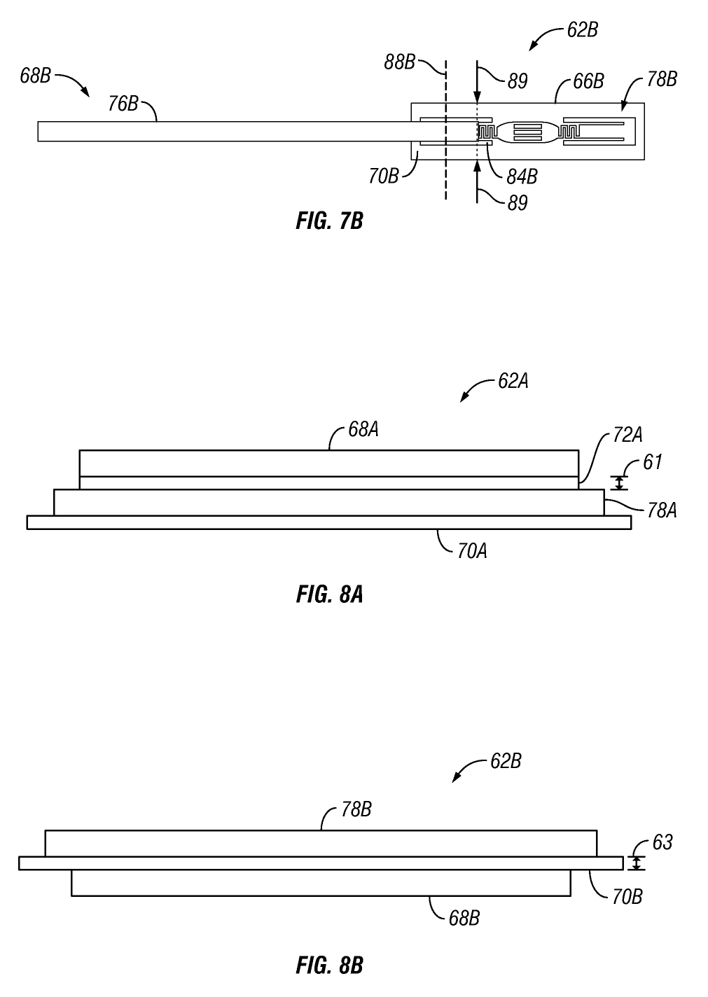

Extension 68 may be attached to UHF RFID tag 66 such that an overlapping portion 74 of extension 68 overlaps with a portion of antenna 78 on UHF RFID tag 66 and a non-overlapping portion 76 of extension 68 extends outwardly from UHF RFID tag 66. As shown in FIG. 6, the overlapping portion 74 of extension 68 may overlap a single radiator 84 of antenna 78 to form an asymmetric extended RFID tag 60. Alternatively, the overlapping portion 74 may overlap with at least portions of both of radiators 84, 86 of antenna 78. Although FIG. 6 shows an example where the extension width 53 is greater than the radiator width 57, other embodiments may have an extension width 53 that is less than or equal to the radiator width 57 as is illustrated in FIGS. 7A-7B.

As shown in FIG. 6, extension 68 may extend outwardly from UHF RFID tag 66 substantially along the same axis formed by radiators 84 and 86 of antenna 78. In other embodiments, however, the extension may run perpendicular to the axis of the antenna or at some other angle.

In some embodiments, an extended RFID tag may be formed by applying an extension to an item that already has a standard UHF RFID tag applied to the item or built into the item. In further embodiments, an extension can be built into or incorporated into an item, such as a file folder or box. Then, a user can subsequently apply a UHF RFID tag 66 to the extension prior to utilizing the item in an RFID system. Alternatively, an integrated RFID tag may be formed by incorporating an extension within the UHF RFID tag at the time of manufacturing.

In one example, extended RFID tag 60 may have the following dimensions: The extension length 51 may be about 5 inches (127 mm) and the extension width 53 may be about 0.25 inches (6.35 mm). The radiator length 55 may be about 1.83 inches (46.5 mm) and the radiator width 57 may be about 0.43 inches (11 mm). The radiator length 55 may refer to the distance from the electrical circuit 80 to the outer most point of one of the radiators of dipole antenna 78. The length of the overlap region 59 may be about 1 inch (25.4 mm). Other lengths and dimensions can be used in order to customize the performance of extended RFID tag 60 for a particular application. For example, in some embodiments, the extension length 51 may be about 4 inches (101.6 mm).

The degree of separation between extension 68 and radiator 84 of antenna 78 may be sufficiently small such that extension 68 capacitively couples with radiator 84 of the dipole antenna 78. Capacitive coupling refers to a form of electromagnetic coupling in which a signal on one conductor is transferred to another by means of the electrical capacitance between the conductors. More specifically, a time-varying voltage applied to extension 68 produces a time-varying electric field between extension 68 and antenna 78 and across insulator 72. The time-varying electric field across insulator 72 in turn induces a time-varying voltage on antenna 78 proportional to the time-varying voltage applied to extension 68. In other words, capacitive coupling may refer to the coupling of conductors by means of the electric field component of an electromagnetic field.

Positioning extension 68 so that the extension electromagnetically couples to antenna 78, but does not conductively connect to antenna 78, may provide several advantages for an RFID system. For example, the electromagnetically coupled antenna and extension structure of extended RFID tag 60 provides an aggregate conductive area that covers substantially more area than a stand-alone dipole antenna of a standard, unmodified UHF RFID tag. This increase in the conductive area of a standard UHF RFID tag may also increase the reception of an electromagnetic field generated by signal line structure 44. Moreover, the increased reception of a near field provided by an extended RFID tag does not significantly alter the far field operating frequency of dipole antenna 78. Thus, extended RFID tag 60 does not experience any significant far field loss due to impedance mismatches that would normally occur if one of the dipoles of antenna 78 was extended or if an extension was conductively coupled to antenna 78. In other words, an extended RFID tag may extend the near field so as to increase the near field reception of a standard UHF RFID tag without necessarily requiring the dipole antenna to be retuned or rebalanced to a new operating frequency.

Extension 68 of extended RFID tag 60 may also improve the performance of an RFID system 40 by facilitating communication between UHF RFID tag 66 and reader 19 in cases where UHF RFID tag 66 is positioned outside of the energization region provided by signal line 17. Further, in RFID systems where a number of closely spaced items exist, such as RFID system 40 shown in FIG. 5, it can be advantageous to utilize coupling between the metallic extensions of the extended tags to assist in the propagation of energy to extensions of surrounding tags. In this way, use of extended RFID tags may increase coupling between items as positional variances occur without substantially varying the operating frequency of the extended tags.

The operation of extended RFID tag 60 will now be described in the case where a portion of extended RFID tag 60 is positioned within the energization region of signal line structure 44. When reader 19 produces an electromagnetic field via signal line structure 44, antenna 78 may receive a portion of the electromagnetic energy directly from the signal line structure 44 as the extension operates as if it were electrically part of the antenna. Antenna 78 may also receive a portion of the electromagnetic energy from extension 68 via electromagnetic or capacitive coupling with extension 68. That is, the electromagnetic field created by signal line structure 44 induces current within extension 68, which in turn causes the extension to radiate a small electromagnetic field in close proximity to the antenna 78 so that the extension operates as part of the antenna electrically. The electromagnetic field radiated by extension 68 may in turn be sensed by UHF RFID tag 66.

When a sufficient amount of energy is received by antenna 78, the electrical circuit 80 may “turn on” and begin to transmit or backscatter a signal containing identification or other information back to the signal line structure 44 by modulating data onto the electromagnetic field. The electrical circuit 80 can modulate data onto the electromagnetic field by adjusting the current flow in antenna 78 according to various modulation schemes known in the art. When reader 19 receives the modulated electromagnetic field from signal line 17, the reader can demodulate the data and provide the identification and other information to the end user.

An extended RFID tag having security features may be manufactured by including materials in extension 68 that are also used in electromagnetic security systems. In one example, extension 68 may be made from magnetic security tape used in an electronic article surveillance (EAS) system, such as 3M Tattle Tape™. By manufacturing an extended RFID tag to include an extension 68 that is compatible with an electromagnetic security system, an extended RFID tag can function as both a tracking device and a security device. For example, a library may use one or more smart shelf RFID systems to store and track library books, and may also use an electromagnetic security system to prevent removal of library books prior to checkout. Applying a single extended RFID tag with security features to an incoming library book allows the smart shelf RFID system to track the library book, and also allows the electromagnetic security system to prevent removal of the library book prior to checkout. Using an extended RFID tag with security features may provide significant cost savings to a library by allowing it to implement both a tracking system and a security system without having to purchase separate tracking tags and security tags for each library book.

FIGS. 7A-7B are schematic diagrams illustrating top views of two different embodiments 62A, 62B of the extended RFID tag 60 shown in FIG. 6. FIG. 7A illustrates an extended RFID tag 62A in which extension 68A is overlaid on top of radiator 84A of antenna 78A to form an overlap portion 74A and a non-overlap portion 76A. Overlap portion 74A may cover a substantial portion of radiator 84A. Extended RFID tag 62A may include an insulator (not shown) formed between extension 68A and radiator 84A to provide direct electrical isolation between extension 68A and antenna 78A. FIG. 7B illustrates an extended RFID tag 62B in which extension 68B is attached to a face of UHF RFID tag 66B opposite antenna 78B to form an overlap portion (not shown) and a non-overlap portion 76B. The overlap portion of extension 68B may extend behind UHF RFID tag 66B to a location indicated by arrows 89 in FIG. 7B.

FIG. 8A is a block diagram illustrating a cross-sectional view of extended RFID tag 62A taken through line 88A of FIG. 7A. Extended RFID tag 62A includes substrate 70A, antenna 78A, insulator 72A, and extension 68A. As illustrated in FIG. 8A, antenna 78A and extension 68A are located on the same side of substrate 70A. Antenna 78A is attached to a face of substrate 70A and insulator 72A is formed between extension 68A and antenna 78A to provide direct electrical isolation (i.e., no direct physical electrical connection) between extension 68A and antenna 78A. In order to provide capacitive coupling between extension 68A and antenna 78A, the extension and antenna may be separated by a small distance 61, which may correspond to the height of insulator 72A. In one example, the distance 61 may be 4-5 mil (0.004-0.005 inches).

FIG. 8B is a block diagram illustrating a cross-sectional view of extended RFID tag 62B taken through line 88B of FIG. 7B. Extended RFID tag 62B includes substrate 70B, antenna 78B, and extension 68B. As illustrated in FIG. 8B, antenna 78B and extension 68B are attached to opposite faces of substrate 70B. Antenna 78B is attached to a first face of substrate 78 B and extension 68B is attached to a second face opposite the first face of substrate 70B. In this embodiment, a material having dielectric properties is included in the substrate 70B to form an insulator between extension 68B and antenna 78B. In order to provide capacitive coupling between extension 68B and antenna 78B, the conductors may be separated by a small distance 63, which may correspond to the height of substrate 70B. In one example, the distance 63 may 4-5 mil

An existing UHF RFID tag 66B may be used for manufacturing extended RFID tag 62B. As one example, UHF RFID tag 66B may be a Rafsec™ tag manufactured by the UPM Raflatac Company. When the existing UHF RFID tag 66B has a substrate 70B with dielectric properties, an extended RFID tag 62B may be manufactured by attaching or applying extension 68B directly onto the back of substrate 70B of UHF RFID tag 66B. For example, a piece of copper tape can be applied to the back of a Rafsec tag to form an extended RFID tag 62B. The copper tape may be about 0.25 inches (6.35 mm) wide or some other width to provide a desired readable range for the extended RFID tag 62B.

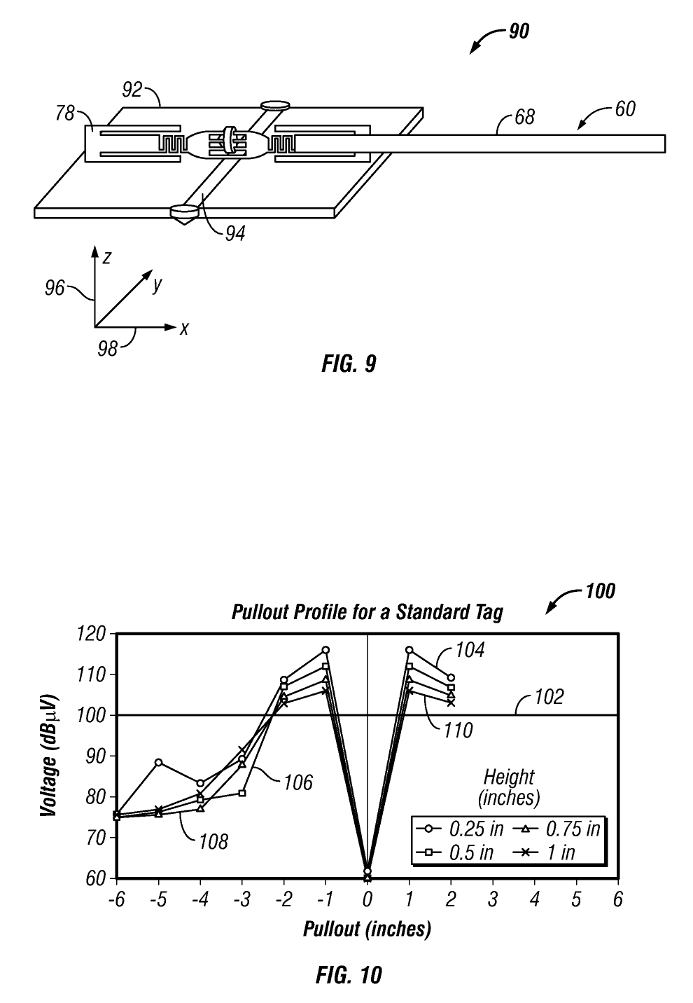

FIG. 9 is a perspective view of a test environment 90 that was modeled in order to simulate the operation of an example extended RFID tag 60. Test environment 90 was modeled to simulate use of an extended RFID tag 60, shelf 92, and signal line 94. Although not shown in FIG. 9, extended RFID tag 60 may include a substrate 70 (FIG. 6) as part of UHF RFID tag 66. FIG. 9 illustrates a placement scenario in which antenna 78 was positioned such that the center of antenna 78 was directly above signal line 94 on the z-axis 96. As noted earlier with respect to FIG. 5, an item having an extended RFID tag 60 may not always be positioned on a shelf so that antenna 78 is centered over signal line 94. This may be due to variation in the location and orientation of the extended RFID tag 60 on an item to which the extended RFID tag 60 is attached and to variation in the location and placement of the item on the shelf 92.

During the modeling, a “pullout” performance of various UHF RFID tags equipped with extensions was computed. The “pullout” distance of a particular configuration refers to a distance between signal line 94 and the center of antenna 78 as measured along the x-axis 98. The pullout performance of a tag refers to the ability of the tag to communicate as a function of its pullout distance. When antenna 78 is centered over signal line 94, as shown in FIG. 9, the extended RFID tag has a pullout of zero inches (0 mm). When extended RFID tag 60 is moved in the positive direction along the x-axis 98, the amount of pullout distance increases. Similarly, when extended RFID tag 60 is moved in the negative direction along the x-axis 98, the amount of pullout decreases (i.e., becomes more negative). If antenna 78 is within the interrogation region of the signal line 94, a voltage drop may be induced across the terminals of antenna 78 in response to electromagnetic radiation produced by signal line 94. A pullout profile can be obtained by modeling the voltage drop across antenna 78 for a set of pullout distances.

FIG. 10 is a graph illustrating a set of pullout profiles 100 modeled for a standard, unmodified UHF RFID tag. That is, the standard tag modeled in FIG. 10 does not include an extension, such as extension 68 illustrated in FIG. 9. Lines 104, 106, 108, 110 represent pullout profiles for heights of 0.25 inches (6.35 mm), 0.5 inches (12.7 mm), 0.75 inches (19.05 mm), and 1 inch (25.4 mm), respectively. The height is the distance between the center of antenna of the UHF RFID tag and signal line along the z-axis 96 when the pullout of the tag is zero.

Solid line 102 represents a target voltage to be realized within the UHF RFID tag for successful RFID communication as measured across the dipoles. In general, as the height of the tag increases, the realized voltage decreases. If the realized voltage exceeds the target voltage for a set of pullout distances, the modeled RFID tag is energized and would be detectable by an RFID reader. If the realized voltage is below the target voltage for a set of pullout distances, the RFID tag may not be able to be detected by the RFID reader

All of the pullout profiles 104, 106, 108, 110 for the standard UHF RFID tag illustrate a strong null (drop) when antenna 78 is centered over signal line 94. Further, only about 2 inches (50.8 mm) of pullout distance can be tolerated before the tag becomes unreadable.

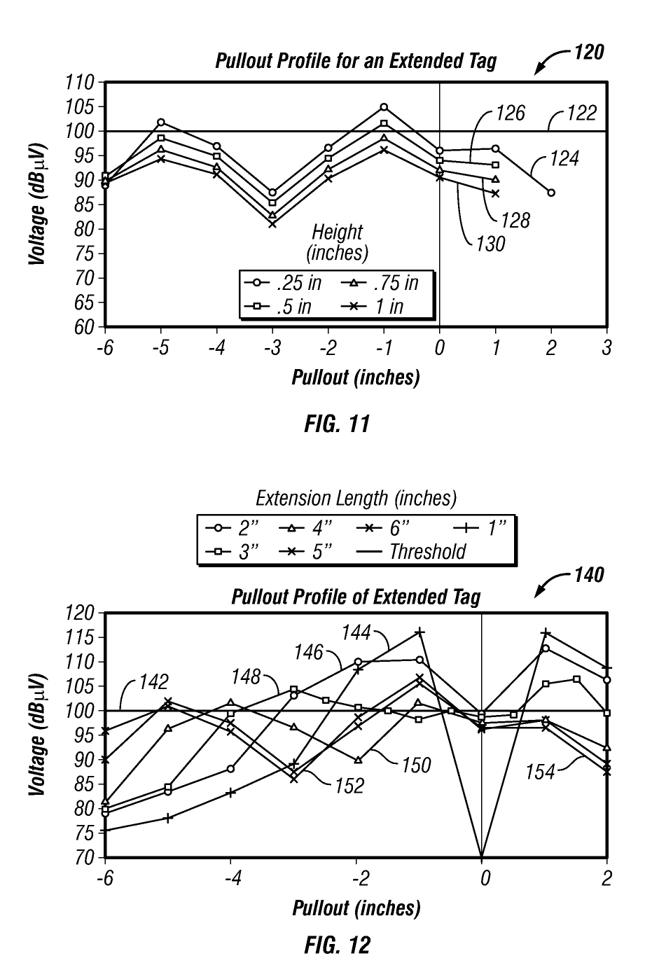

FIG. 11 is a graph illustrating a set of pullout profiles 120 determined upon modeling an exemplary extended RFID tag 60 according to this disclosure. Lines 124, 126, 128, 130 represent pullout profiles for heights 0.25 inches (6.35 mm), 0.5 inches (12.7 mm), 0.75 inches (19.05 mm), and 1 inch (25.4 mm), respectively. The extended RFID tag 60 had a one inch (25.4 mm) overlap length 59 and a four inch (101.6 mm) extension length 51 (FIG. 6). The extended RFID tag 60 was composed of a 0.25 inch (6.35 mm) piece of copper tape applied to the back side of a standard tag. Solid line 122 represents a target voltage for typical application utilizing an extended RFID tag 60, such as RFID system 40 shown in FIG. 5. As can be seen in FIG. 11, the extended RFID tag 60 reduces the null generated by the standard tag at a pullout distance of zero inches (0 mm). Thus, extension 68 can improve performance in an RFID system even when antenna 78 is centered over signal line 94. FIG. 11 also shows that extended RFID tag 60 may have approximately 2 inches (50.8 mm) of continuous read range followed by approximately 2 inches (50.8 mm) of unreadable range. After the 2 inches (50.8 mm) of unreadable range, extended RFID tag 60 may have an additional 1 inch (25.4 mm) of read range between pullout distances of 4 inches (101.6 mm) and 5 inches (127 mm).

FIG. 12 is a graph illustrating another set of pullout profiles 140 determined upon modeling a second exemplary extended RFID tag 60 according to this disclosure. Lines 144, 146, 148, 150, 152, 154 represent pullout profiles for extension lengths of 1 inch (25.4 mm), 2 inches (50.8 mm), 3 inches (76.2 mm), 4 inches (101.6 mm), 5 inches (127 mm), and 6 inches (152.4 mm), respectively. Solid line 142 represents a target voltage for typical applications utilizing an extended RFID tag 60, such as RFID system 40 shown in FIG. 5. Each of the pullout profiles 144, 146, 148, 150, 152, 154 was for a modeled extended RFID tag having a one inch (25.4 mm) overlap length 59 and a height of 0.25 inches (6.35 mm). The extended RFID tag 60 was composed of a 0.25 inch (6.35 mm) piece of copper tape applied to the back side of a standard tag. Comparing FIGS. 11 and 12 illustrates that an extended RFID tag having a one inch (25.4 mm) extension, represented by line 144 in FIG. 12, gives a pullout profile that is very similar to the pullout profile of a standard tag without any extension as shown in FIG. 11. Further, profile 148 indicates that a 3 inch (76.2 mm) extension allows for about 4 inches (101.6 mm) of pullout with no nulls.

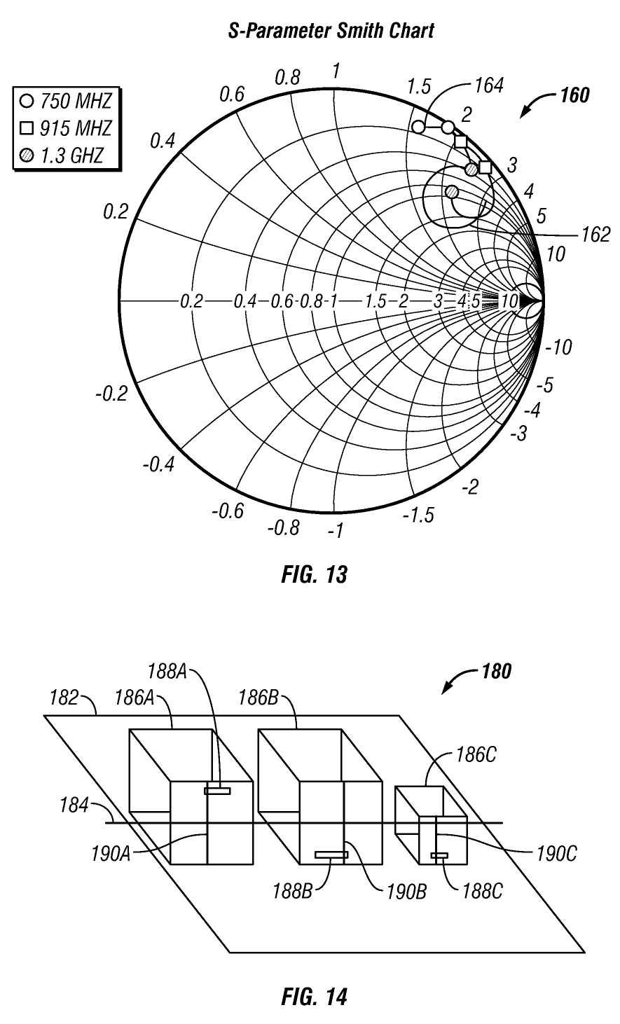

FIG. 13 is an s-parameter smith chart illustrating the electrical characteristics of a standard, unmodified UHF RFID tag verses an extended RFID tag according to this disclosure. Curve 162 illustrates the scattering or impedance characteristics for the standard UHF RFID tag at various UHF frequencies. Curve 164 illustrates the scattering or impedance characteristics for extended RFID tag 60 at various UHF frequencies. The curves show very little shift in the impedance characteristics between the standard UHF RFID tag without extension and extended RFID tag 60, indicating that an extended RFID tag 60 may be used in long read range (i.e., far field) applications without significant signal degradation.

FIG. 14 is a perspective view of another exemplary RFID system 180 according to this disclosure. RFID system 180 includes shelf 182, signal line 184, boxes 186A-186C (collectively, “boxes 186”), UHF RFID tags 188A-188C (collectively, “UHF RFID tags 188”), and extensions 190A-190C (collectively, “extensions 190”). The shelf 182 is provided for storing and tracking of boxes 186. Signal line 184 provides an electromagnetic field for the RFID system 180 and receives backscattered electromagnetic field from the UHF RFID tags 188. The boxes 186 may hold various items to be stored, such as inventory in a warehouse. The extensions 190 are provided to improve the readable area of boxes 186 when the boxes are tagged and placed within RFID system 180. The extensions 190 may be made out of materials that are the same or similar to those used for extension 68 of extended RFID tag 60, e.g., a 0.25 inch (6.35 mm) strip of copper.

In one example, extensions 190 may be incorporated into each of the boxes 186 during the manufacture of the boxes 186. Then, a user may apply UHF RFID tags 188A-188C onto boxes 186A-186C, respectively, to allow for improved tracking of the boxes 186 or items within the boxes. In another example, a user may apply extensions 190 to boxes 188 during the use of RFID system 180 to improve the tracking of items within the RFID system 180. By utilizing boxes 186 that include extensions 190, the tolerance with respect to variation in UHF RFID tag 188 placement may be improved. In addition, the tolerance with respect to variation in the placement of boxes 186 on shelf 182 may also be improved.

Although FIG. 14 displays boxes 186 having extensions 190 that run in a substantially vertical direction, it should be recognized that boxes 186, may have extensions 190 that run in other directions as well and on other faces of the boxes. For example, boxes 186 may include extensions that run across the bottom of the boxes on a plane substantially parallel to the shelf. In addition, boxes 186 may have multiple extensions on multiple different faces of each of the boxes, where each of the extensions on a particular box are electromagnetically or conductively coupled to each other.

The extended RFID tag can improve the performance of an RFID system. For example, the extended tag may increase the reception area of a standard UHF RFID tag without significantly altering the far field operating frequency of the dipole antenna in the standard UHF RFID tag. In other words, an extended RFID tag may increase the near field reception of a standard UHF RFID tag without requiring the dipole antenna to be retuned or rebalanced to a new operating frequency.

In addition, an extended RFID tag may increase the readable area of a tagged item and improve the tolerance in an RFID system with respect to variation in the placement and orientation of both the tag and the item to which the tag is attached. Moreover, an extended RFID tag may also be able to reduce the power consumption in an RFID system because of the increased electromagnetic coupling provided by the extended RFID tags. The increased electromagnetic coupling can allow the strength of the electromagnetic field produced by the transmitter to be reduced without compromising performance in the system. Further, in RFID systems where a number of closely spaced items exist, it can be advantageous to utilize coupling between the metallic extensions of the extended tags to assist in the propagation of energy to extensions of surrounding tags. In this way, use of extended RFID tags may increase coupling between items as positional variances occur without substantially varying the far field operating frequency of the extended tags.

An extended RFID tag may also improve performance in RFID systems that include handheld applications. For example, a warehouse may contain numerous items, such as pallets containing a plurality of boxes. A warehouse operator may use a handheld RFID reader to track where an item of interest is located in the warehouse and on which pallet the item of interest is located by going around the warehouse and “polling” each pallet with the reader to determine what items are on a particular pallet. When polling a pallet, an electromagnetic field generated by the handheld RFID reader may not be able to adequately penetrate through the stacks of boxes to properly energize RFID tags associated with all of the items on the pallet. For example, some boxes that are located underneath, between, or behind other boxes may be effectively hidden from the RFID reader. An extended RFID tag may improve coupling between the RFID reader and RFID tags that are located on hidden boxes, by allowing the electromagnetic energy received by items that receive the most electromagnetic energy to couple to RFID tags of the hidden boxes that may not be receiving enough electromagnetic energy to operate. In another example involving a handheld application, a tagged item of interest may be located in an area that is hard to interrogate, such as a sub assembly. An extended RFID tag can improve detection and tracking in hard to interrogate areas because the extension may provide a coupling path between the tagged item of interest and a location that is more readily accessible to the RFID reader.

Various embodiments of the invention have been described. For example, an extended RFID tag that improves tolerance with respect to variation in placement of the RFID tag and variation in the placement of the item of interest has been disclosed. Nevertheless, various modifications can be made to the techniques described above. These and other embodiments are within the scope of the following claims.

1. An extended radio-frequency identification (RFID) tag comprising:
an ultra-high frequency (UHF) RFID tag having a dipole antenna attached to a first surface of a substrate;
an antenna extension attached to the UHF RFID tag and overlapping at least a portion of the dipole antenna for electromagnetically coupling the antenna extension and the dipole antenna in operation; and
an insulator positioned between the dipole antenna and the antenna extension to electrically isolate the dipole antenna from the antenna extension.

2. The extended RFID tag of claim 1, wherein the dipole antenna is positioned between the substrate of the UHF RFID tag and the insulator.

3. The extended RFID tag of claim 1, wherein the substrate of the UHF RFID tag is the insulator positioned between the dipole antenna and the antenna extension.

4. The extended RFID tag of claim 1, wherein at least a portion of the antenna extension extends outwardly from the UHF RFID tag.

5. The extended RFID tag of claim 1, wherein the dipole antenna has two radiators and the antenna extension overlaps at least half of one of the radiators.

6. The extended RFID tag of claim 5, wherein the antenna extension is an elongated rectangle having a length substantially parallel to an axis formed by the two radiators of the dipole antenna and a width substantially perpendicular to the axis formed by the two radiators.

7. The extended RFID tag of claim 6, wherein the length of the antenna extension is at least 4 times greater than a length of a portion of the antenna extension overlapping the dipole antenna.

8. The extended RFID tag of claim 6, wherein the length of the antenna extension is at least 2 times greater than a length of one of the radiators of the dipole antenna.

9. The extended RFID tag of claim 6, wherein the width of the antenna extension is less than a width of the dipole antenna.

10. The extended RFID tag of claim 6, wherein the width of the antenna extension is greater than or equal to a width of the dipole antenna.

11. The extended RFID tag of claim 1, wherein a length of a portion of the antenna extension overlapping the dipole antenna is at least one inch.

12. The extended RFID tag of claim 1, wherein the insulator has a width that separates the antenna extension and the dipole antenna by no more than 5 mil (0.005 inches) for capacitively coupling the antenna extension and the dipole antenna in operation.

13. The extended RFID tag of claim 1, wherein the antenna extension comprises a magnetic security tape for an electronic article surveillance (EAS) system.

14. A radio-frequency identification (RFID) system, comprising:
a storage area for storing an item;
an extended radio-frequency identification (RFID) tag applied to the item;
a transmitter proximate the storage area to produce an electromagnetic field; and
a reader coupled to the transmitter to receive a backscattered electromagnetic signal from the extended RFID tag;
wherein the extended RFID tag comprises an ultra-high frequency (UHF) RFID tag having a dipole antenna attached to a first surface of a substrate, an antenna extension attached to the UHF RFID tag and overlapping at least a portion of the dipole antenna for electromagnetically coupling the antenna extension and the dipole antenna in operation, and an insulator positioned between the dipole antenna and the antenna extension to electrically isolate the dipole antenna from the antenna extension.

15. The RFID system of claim 14, wherein the storage area comprises a shelf having at least one signal line.

16. A method, comprising:
selecting an ultra-high frequency (UHF) radio-frequency identification (RFID) tag having an integrated circuit and a dipole antenna having two radiators coupled to the integrated circuit;
selecting an antenna extension having a length that exceeds a length of one of the radiators of the UHF RFID tag;
applying the antenna extension to the UHF RFID tag to overlap a portion of one of the radiators of the dipole antenna, wherein the antenna extension and the UHF RFID tag together form an extended RFID tag.

17. The method of claim 16, further comprising:
applying the extended RFID tag to an item; and
placing a portion of the extended RFID tag proximate to a reader in an RFID system;
transmitting an electromagnetic field from the reader into an interrogation region of the RFID system;
receiving the electromagnetic field at the extended RFID tag; and
modulating data onto the electromagnetic field in response to the extended RFID tag receiving the electromagnetic field.
receiving a data modulated electromagnetic field at the reader; and
detecting the presence of the extended RFID tag within the interrogation region of the RFID system.

18. The method of claim 16, wherein the antenna extension is applied to overlap at least half of one of the radiators.

19. The method of claim 16, wherein the antenna extension is an elongated rectangle.

20. The method of claim 16, wherein the antenna extension is selected to have a length that exceeds a length of a portion of the antenna extension overlapping the dipole antenna by at least 4 times.

21. The method of claim 16, wherein the antenna extension is selected to have a length that exceeds the length of one of the radiators of the dipole antenna by at least 2 times.

22. The method of claim 16, wherein the antenna extension is selected to have a width less than a width of the dipole antenna.

23. The method of claim 16, wherein the antenna extension is selected to have a width greater than or equal to a width of the dipole antenna.

24. The method of claim 16, wherein the antenna extension is applied to overlap at least one inch of the dipole antenna.

25. The method of claim 16, wherein the antenna extension is applied to provide a separation between the antenna extension and the dipole antenna of no more than 5 mils (0.005 inches) for capacitively coupling the antenna extension and the dipole antenna in operation.
